(19) United States
(12) Patent Application Publication
(10) Pub. No.: US 2013/0326122 A1
(43) Pub. Date: Dec. 5, 2013

(54) DISTRIBUTED MEMORY ACCESS IN A NETWORK

(71) Applicant: INTERNATIONAL BUSINESS MACHINES CORPORATION, Armonk, NY (US)

(72) Inventors: Patrick Droz, Rueschlikon (CH); Antonius P. Engbersen, Rueschlikon (CH); Christoph Hagleitner, Rueschlikon (CH); Ronald P. Luijten, Rueschlikon (CH); Bernard Metzler, Zurich (CH); Martin L. Schmatz, Rueschlikon (CH); Patrick Stuedi, Rueschlikon (CH); Animesh Kumar Trivedi, Rueschlikon (CH)

(73) Assignee: INTERNATIONAL BUSINESS MACHINES CORPORATION, Armonk, NY (US)

(21) Appl. No.: 13/898,974

(22) Filed: May 21, 2013

(30) Foreign Application Priority Data
May 31, 2012 (GB) 1209676.4

(51) Int. Cl. G06F 12/14; G06F 12/02

(52) U.S. Cl. CPC G06F 12/1458; G06F 12/0246
USPC 711/103; 711/152

(57) ABSTRACT

A method of distributed memory access in a network, the network including a plurality of distributed compute elements, at least one control element and a plurality of distributed memory elements, wherein a data element is striped into data segments, the data segments being imported on at least a number of the distributed memory elements by multiple paths in the network, includes receiving, by a requesting element, credentials including an access permission for accessing the number of distributed memory elements and location information from the control element, the location information indicating physical locations of the data segments on the number of distributed memory elements; and launching, by the requesting element, a plurality of data transfers of the data segments over the multiple paths in the network to and/or from the physical locations.

### PRIORITY

This application claims priority to Great Britain Patent Application No. 1209676.4, filed May 31, 2012, and all the benefits accruing therefrom under 35 U.S.C. §119, the contents of which in its entirety are herein incorporated by reference.

### BACKGROUND

The invention relates to a method of distributed memory access in a network.

Publication US 2011/0320558 shows a network with distributed shared memory. The network includes a clustered memory cache aggregated from and comprised of physical memory locations on a plurality of physically distinct computing systems. The network also includes a plurality of local cache managers, each of which are associated with a different portion of the clustered memory cache, and a metadata service operatively coupled with the local cache managers. Further, a plurality of clients is operatively coupled with the metadata service and the local cache managers. In response to a request issuing from any of the clients for a data item present in the clustered memory cache, the metadata service is configured to respond with identification of the local cache manager associated with the portion of the clustered memory cache containing such data item.

U.S. Pat. No. 6,026,464 describes a memory control system and a method for controlling access to a global memory. The global memory has multiple memory banks coupled to a memory bus. Multiple memory controllers are coupled between processing devices and the memory bus. The memory controllers control access of the processing devices to the multiple memory banks by independently monitoring the memory bus with each memory controller. The memory controllers track which processing devices are currently accessing which memory banks. The memory controllers overlap bus transactions for idle memory banks. The bus transactions include a control bus cycle that initially activates the target memory bank and data bus cycles that transfer data for previously activated memory banks. A control bus arbiter coupled to the memory bus grants activation of the multiple memory banks according to a first control bus request signal and a separate data bus arbiter operating independently of the control bus arbiter grants data transfer requests according to a second data bus request signal.

Conventional solutions, like the above mentioned, may have a limited bandwidth, in particular due to single connection and/or interface bottlenecks. A single connection bottleneck arising due to congested or overloaded intermediate network nodes e.g., switches.

Conventional solutions may be not aware of rich physical connection topology, and hence multipaths available between a pair of communicating nodes in a distributed system. Some of these paths could be less congested than the one in the use. Examples of rich connection topologies that offer multipaths are mesh networks, fat tree networks etc.

### SUMMARY

In one embodiment, a method of distributed memory access in a network, the network including a plurality of distributed compute elements, at least one control element and a plurality of distributed memory elements, wherein a data element is striped into data segments, the data segments being imported on at least a number of the distributed memory elements by multiple paths in the network, includes receiving, by a requesting element, credentials including an access permission for accessing the number of distributed memory elements and location information from the control element, the location information indicating physical locations of the data segments on the number of distributed memory elements; and launching, by the requesting element, a plurality of data transfers of the data segments over the multiple paths in the network to and/or from the physical locations.

In another embodiment, a computer readable storage medium comprising computer readable instructions stored thereon that, when executed by a computer, implement a method of distributed memory access in a network, the network including a plurality of distributed compute elements, at least one control element and a plurality of distributed memory elements, wherein a data element is striped into data segments, the data segments being imported on at least a number of the distributed memory elements by multiple paths in the network. The method includes receiving, by a requesting element, credentials including an access permission for accessing the number of distributed memory elements and location information from the control element, the location information indicating physical locations of the data segments on the number of distributed memory elements; and launching, by the requesting element, a plurality of data transfers of the data segments over the multiple paths in the network to and/or from the physical locations.

In another embodiment, a system includes a network including a plurality of distributed compute elements, at least one control element and a plurality of distributed memory elements, wherein a data element is striped into data segments, the data segments being imported on at least a number of the distributed memory elements by multiple paths in the network; and a requesting element, configured to receive credentials including an access permission for accessing the number of distributed memory elements and location information from the control element, the location information indicating physical locations of the data segments on the number of distributed memory elements; and the requesting element configured to launch a plurality of data transfers of the data segments over the multiple paths in the network to and/or from the physical locations.

### BRIEF DESCRIPTION OF THE SEVERAL VIEWS OF THE DRAWINGS

FIG. 1 shows an embodiment of a sequence of method operations of distributed memory access in a network;

FIG. 2 shows a schematic block diagram of a first embodiment of a network configured for the distributed memory access of FIG. 1;

FIG. 3 shows the embodiment of the network of FIG. 2 executing block 101 of FIG. 1;

FIG. 4 shows the embodiment of the network of FIG. 2 executing block 102 of FIG. 1;

FIG. 5 shows a schematic block diagram of a second embodiment of a network configured for the distributed memory access of FIG. 1;

FIG. 6 shows a schematic block diagram of a third embodiment of a network configured for the distributed memory access of FIG. 1;

FIG. 7 shows a schematic block diagram of a fourth embodiment of a network configured for the distributed memory access of FIG. 1; and

FIG. 8 shows a schematic block diagram of an embodiment of a system adapted for distributed memory access.

Similar or functionally similar elements in the figures have been allocated the same reference signs if not otherwise indicated.

### DETAILED DESCRIPTION

According to a first aspect, a method of distributed memory access in a network is suggested. The network includes a plurality of distributed compute elements, at least one control element and a plurality of distributed memory elements. A data element is striped into data segments, the data segments being imported on at least a number of the distributed memory elements by multiple paths in the network. In a first operation, a requesting element is receiving credentials from the control element. The credentials include access permission for accessing the number of distributed memory elements and location information. The location information is adapted to indicate physical locations of the data segments on the number of distributed memory elements. In a second operation, the requesting element is launching a plurality of data transfers of the data segments over the multiple paths in the network to and/or from the physical locations.

According to some implementations, a data element may be chopped up in parts—the so called data segments—which then get stored on multiple distributed memory elements. For a single “logical” data access request, multiple connections may be opened using the multiple paths that are available in the network between a single requesting element from where the logical request is originated to multiple memory elements where the striped data parts are stored.

According to some implementations, the multiple paths may be a possible set of network paths between pairs of compute elements.

According to some implementations, the memory element may be adapted to provide memory to network. Further, according to some implementations, the compute element is adapted to provide processing power to the network.

According to some implementations, limited bandwidth and limited memory amount are overcome.

According to some implementations, the network may be a system of interconnects that connect a single or a group of compute elements or processing elements, e.g. processors, or specialized nodes with FPGA (FPGA; Field Programmable Gate Array) with each other. It may be external, e.g. LAN, or internal, e.g. processor interconnects, or multiple NICs (NIC; Network Interface Card) within a single server, for a given system installation. In the latter, a possible mode of communication would be: A first processor P1 may access a first NIC1 and send data using the first NIC1 to a second NIC2 via the network. Moreover, a second NIC2 is handled and/or processed by a second processor P2, which receives the data. Even though all four entities P1, P2, NIC1, NIC2 may be part of a single physical system.

In an embodiment, before the first operation, the requesting element is asking the control element for the credentials including the access permission and the location information.

In a further embodiment, before the first operation, a further requesting element is asking the control element for the credentials and forwarding the received credentials to the requesting element.

In a further embodiment, the plurality of compute elements, the at least one control element and the plurality of memory elements are integrated in one single physical machine.

In a further embodiment, the plurality of compute elements, the at least one control element and the plurality of memory elements are integrated in different physical machines coupled by the network.

In a further embodiment, the functionality of the control element, in particular providing the credentials, may be distributed on a plurality of entities in the network.

In a further embodiment, at least one data segment is replicated, the at least one replicated data segment being imported on at least one redundant memory element distributed in the network and controlled by the control element or at least one redundant control element.

In a further embodiment, the data segments are replicated, the replicated data segments being imported on a number of redundant memory elements distributed in the network and controlled by the control element or at least one redundant control element. The redundant memory elements are redundant to the number of distributed memory elements storing the data segments of the data.

In a further embodiment, the data segment is located on volatile or non-volatile Random Access Memory (RAM), or where the data segment is located on a storage medium, or any hybrid combination thereof, including using the Random Access Memory as cache for the data segments on the storage medium.

In a further embodiment, the data element is striped into data segments having a constant size.

In a further embodiment, the size of the data segments is configured or adapted.

In a further embodiment, the data element is striped into data segments having different sizes.

In a further embodiment, the different sizes of the data segments are configured or adapted.

In a further embodiment, multiple requesting elements are accessing one memory element of the number of memory elements storing the data segments at the same time.

In a further embodiment, the method includes a operation of forwarding the received access permission and the received location information from the requesting element to at least one further requesting element.

In a further embodiment, the distributed memory elements are configured to expose and make memory network addressable. For example, the distributed memory elements are configured for RDMA (RDMA; Remote Direct Memory Access).

Any embodiment of the first aspect may be combined with any embodiment of the first aspect to obtain another embodiment of the second aspect.

According to a second aspect, a computer program is suggested which comprises a program code for executing the method of the above first aspect of distributed memory access in a network when run on at least one computer.

According to a third aspect, a device of distributed memory access in a network is suggested. The network includes a plurality of distributed compute elements, at least one control element and a plurality of distributed memory elements. A data element is striped into data segments, the data segments being imported on at least a number of the distributed memory elements by multiple paths in the network. The device includes a requesting element. The requesting element is configured to receive credentials including access permission for accessing the number of distributed memory elements and location information from the control element, the location information indicating physical locations of the data segments on the number of distributed memory elements. Further, the requesting element is configured to launch a plurality of data transfers of the data segments over the multiple paths in the network to and/or from the physical locations.

In the following, exemplary embodiments of the present invention are described with reference to the enclosed figures.

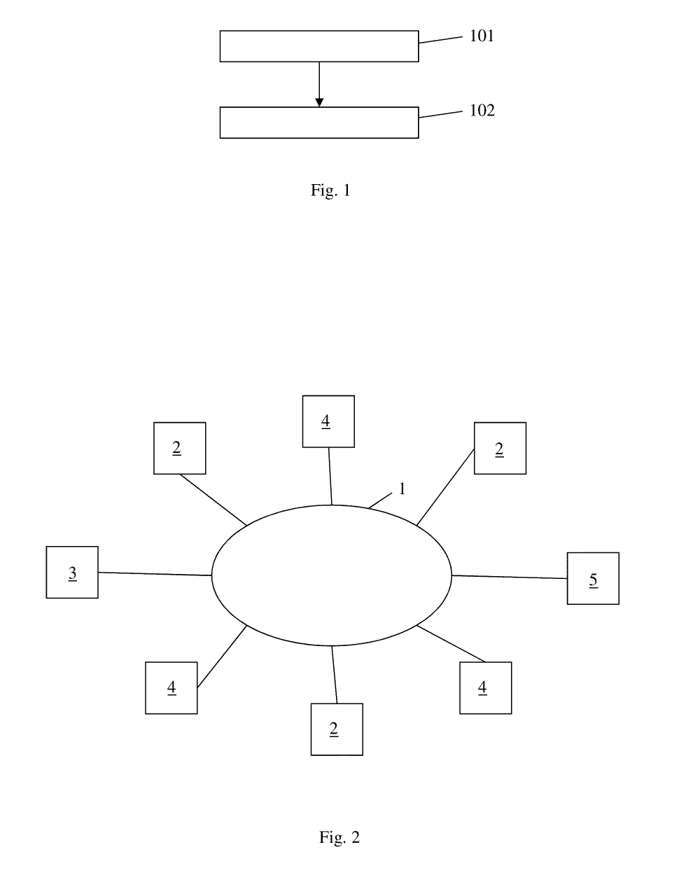

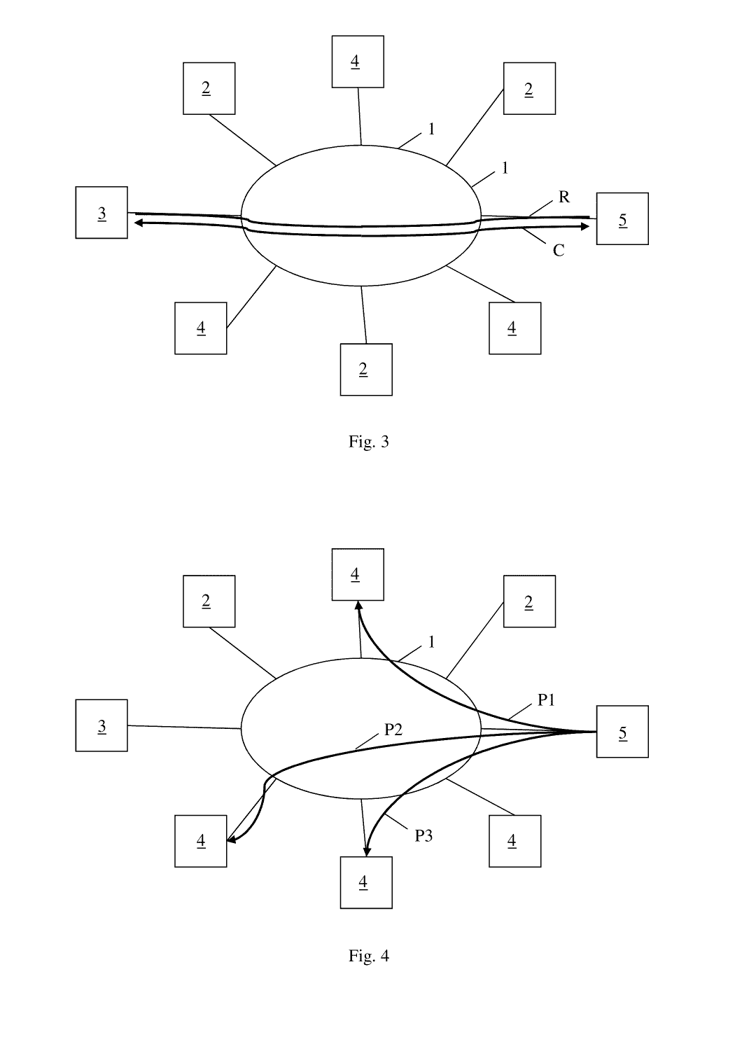

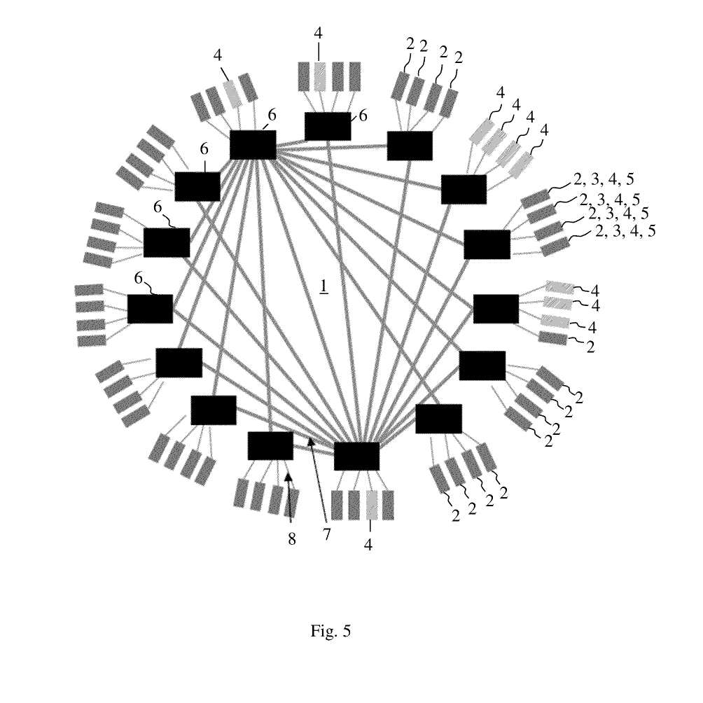

In FIG. 1, an embodiment of a sequence of method operations of distributed memory access in a network 1 is depicted. In this regard, FIG. 2 shows a schematic block diagram of a first embodiment of such a network 1 configured for the distributed memory access of FIG. 1. Moreover, FIG. 3 shows the embodiment of the network 1 of FIG. 2 executing block 101 of FIG. 1, and FIG. 4 depicts the embodiment of the network 1 of FIG. 2 executing block 102 of FIG. 1.

The network 1 includes a plurality of distributed compute elements 2, at least one control element 3, a plurality of distributed memory elements 4, and a requesting element 5. A data element is striped into data segments, the data segments being imported on at least a number of the distributed memory elements 4 by multiple paths P1-P3 in the network 1 (see FIG. 4).

In block 101 of FIG. 1, the requesting element 5 receives credentials C from the control element. The credentials C include an access permission for accessing the number of distributed memory elements 4 and location information (see FIG. 3). Memory elements 4 upon receiving a data segment access request check whether the request element 5 has provided an appropriate credentials C to access the data segment. The location information is adapted to indicate physical locations of the data segments on the number of distributed memory elements 4. In the example of FIG. 3, the requesting element 5 sends a request R to the control element 3 and receives the credentials C in response to the request R.

In block 102, the requesting element 5 launches a plurality of data transfers of the data segments over the multiple paths P1-P3 in the network 1 to the physical locations.

In the example of FIG. 4, in block 102, the requesting element 5 launches data transfers of the data segment over three paths P1-P3 to three memory elements 4.

FIG. 5 shows a schematic block diagram of a second embodiment of a network 1 configured for distributed memory access of FIG. 1. The network 1 of FIG. 5 is a mesh network having a plurality of hidden layer system network connections 7 coupling a plurality of network aggregation nodes 6. The network aggregation nodes 6 may be embodied by switches. Each of the switches 6 is coupled by a compute system network connection 8 to an element which may be embodied as a compute element 2, as a memory element 4 or as an element 2, 3, 4, 5 which is configured to function as compute element, control element, memory element and requesting element. In the example of FIG. 5, a memory can be shared by all elements which are embodied by a memory element or which are configured to function as a memory element. Further, for providing the distributed memory access of FIG. 1, the full-mesh hidden layer network 1 of FIG. 5 may not be changed in its structure. In particular, in the example of FIG. 5, logical memory locations 4 may be striped across several or many physical locations.

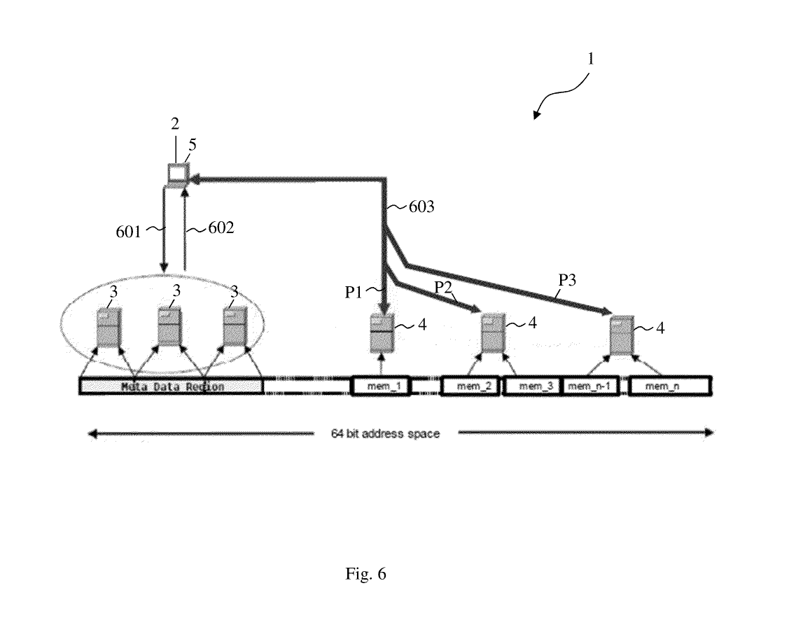

This is explained in more detail with reference to FIG. 6 which shows a third embodiment of a network 1 configured for the distributed memory access of FIG. 1. In FIG. 6, a requesting element 5, three control elements 3 and three memory elements 4 are depicted.

In block 601 of FIG. 6, the requesting element 5 requests credentials C from one of the control elements 3 for accessing the three distributed memory elements 4. The requesting element 5 of FIG. 6 functions also as a compute element 2. Further, the credentials C which are received in block 602 by the requesting element 5 may include location information, wherein the location information indicate the physical locations of the data segments on the three distributed memory elements 4.

In block 603, the requesting element 5 launches a number of data transfers of the data segments over three paths P1, P2, P3 to the physical locations of the three memory elements 4.

Further, in FIG. 6, an example of a 64-bit address space for addressing the control element 3 and memory elements 4 is depicted exemplarily. The compute element 2 of FIG. 6 is connected to a plurality of distributed elements 4 in the network. The data is striped across the distributed memory elements 4 including full-bandwidth conservation and a transparent 64-bit address space. Each of the striped data locations, e.g. segments or pages, is assigned to be owned by a redundant server. Thus, also redundancy may be provided.

As indicated by above blocks 601-602, the requesting element 5, for example a requesting server, is asking and receiving the credentials including the access permission plus the physical locations of the striped data locations from the redundant server pair 3. This may be called the control path.

In the following block 603, the requesting server 5 is launching a plurality of network transfers to the striped data locations 4. That may be called the data path.

The inherent separation of control and data operations during memory access allow for an improved mapping onto RDMA network principles and semantics. The present memory system may serve as a base for, file system, database system, Hadoop system and named object system.

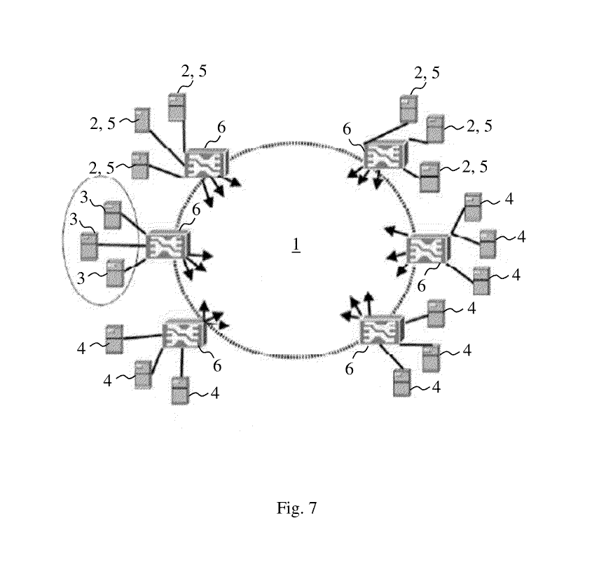

In this regard, FIG. 7 shows another embodiment of the network 1 configured for the distributed memory access of FIG. 1. FIG. 7 shows a full-mesh network 1 which connects a plurality of switches 6, wherein to each switch 6, computer elements 2, control elements 3, memory elements 4 and requesting elements 5 are coupled. It may be noted that each leaf node of the full-mesh network 1 of FIG. 7 may function as an element including at least one of the following compute element 2, control element 3, memory element 4 and requesting element 5.

Another embodiment of the network 1 configured for the distributed memory access of FIG. 1 may be based on a fat-tree connection topology.

Fat-tree may be used as a connection topology in datacenters. The nodes are connected using three levels of switches including edge switches, aggregation switches, and core switches. In fat tree connection topology, there are multiple possible paths available between a pair of nodes. So if a particular switch is congested, one may use another path that does not include that switch. This may also help with the performance as multiple parallel connections can be opened between a requesting element and a memory element that stores multiple data segments. All these parallel connection can use different paths, and hence avoiding interference with each other. This results in less congestion, low packet losses, and higher performance than conventional solutions.

Computerized devices can be suitably designed for implementing embodiments of the present invention as described herein. In that respect, it can be appreciated that the methods described herein are largely non-interactive and automated. In exemplary embodiments, the methods described herein can be implemented either in an interactive, partly-interactive or non-interactive system. The methods described herein can be implemented in software (e.g., firmware), hardware, or a combination thereof. In exemplary embodiments, the methods described herein are implemented in software, as an executable program, the latter executed by suitable digital processing devices. In further exemplary embodiments, at least one block or all blocks of above method of FIG. 1 may be implemented in software, as an executable program, the latter executed by suitable digital processing devices. More generally, embodiments of the present invention can be implemented wherein general-purpose digital computers, such as personal computers, workstations, etc., are used.

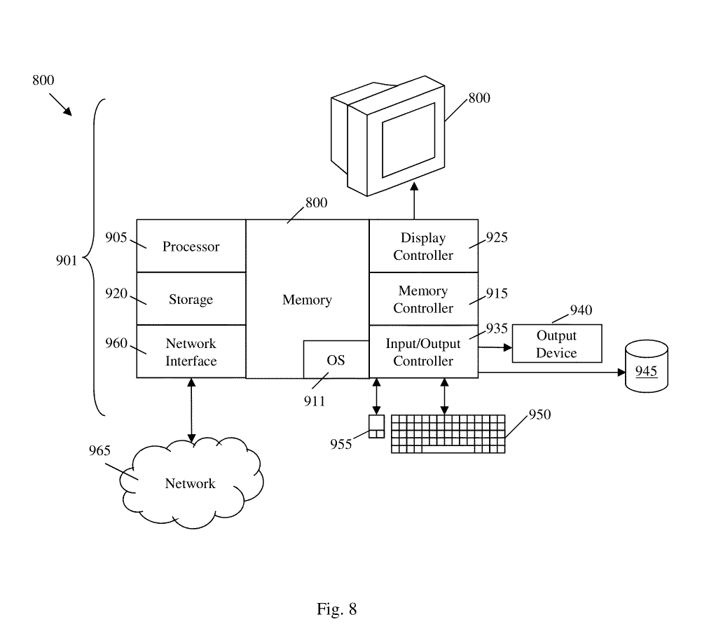

For instance, the system 900 depicted in FIG. 8 schematically represents a computerized unit 901, e.g., a general-purpose computer. The computerized unit 901 may embody the compute element 2, the control element 3, the memory element 4 or requesting element 5 of one of FIGS. 2 to 7. In exemplary embodiments, in terms of hardware architecture, as shown in FIG. 8, the unit 901 includes a processor 905, memory 910 coupled to a memory controller 915, and one or more input and/or output (I/O) devices 940, 945, 950, 955 (or peripherals) that are communicatively coupled via a local input/output controller 935. The input/output controller 935 can be, but is not limited to, one or more buses or other wired or wireless connections, as is known in the art. The input/output controller 935 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 905 is a hardware device for executing software, particularly that stored in memory 910. The processor 905 can be any custom made or commercially available processor, a central processing unit (CPU), an auxiliary processor among several processors associated with the computer 901, a semiconductor based microprocessor (in the form of a microchip or chip set), or generally any device for executing software instructions.

The memory 910 can include any one or combination of volatile memory elements (e.g., random access memory) and nonvolatile memory elements. Moreover, the memory 910 may incorporate electronic, magnetic, optical, and/or other types of storage media. Note that the memory 910 can have a distributed architecture, where various components are situated remote from one another, but can be accessed by the processor 905.

The software in memory 910 may include one or more separate programs, each of which comprises an ordered listing of executable instructions for implementing logical functions. In the example of FIG. 8, the software in the memory 910 includes methods described herein in accordance with exemplary embodiments and a suitable operating system (OS) 911. The OS 911 essentially controls the execution of other computer programs, such as the methods as described herein (e.g., FIG. 1), and provides scheduling, input-output control, file and data management, memory management, and communication control and related services.

The methods described herein may be in the form of a source program, executable program (object code), script, or any other entity comprising a set of instructions to be performed. When in a source program form, then the program needs to be translated via a compiler, assembler, interpreter, or the like, as known per se, which may or may not be included within the memory 910, so as to operate properly in connection with the OS 911. Furthermore, the methods can be written as an object oriented programming language, which has classes of data and methods, or a procedure programming language, which has routines, subroutines, and/or functions.

Possibly, a conventional keyboard 950 and mouse 955 can be coupled to the input/output controller 935. Other I/O devices 940-955 may include sensors (especially in the case of network elements), i.e., hardware devices that produce a measurable response to a change in a physical condition like temperature or pressure (physical data to be monitored). Typically, the analog signal produced by the sensors is digitized by an analog-to-digital converter and sent to controllers 935 for further processing. Sensor nodes are ideally small, consume low energy, are autonomous and operate unattended.

In addition, the I/O devices 940-955 may further include devices that communicate both inputs and outputs. The system 900 can further include a display controller 925 coupled to a display 930. In exemplary embodiments, the system 900 can further include a network interface or transceiver 960 for coupling to a network 965.

The network 965 transmits and receives data between the unit 901 and external systems. The network 965 is possibly implemented in a wireless fashion, e.g., using wireless protocols and technologies, such as WiFi, WiMax, etc. The network 965 may be a fixed wireless network, a wireless local area network (LAN), a wireless wide area network (WAN) a personal area network (PAN), a virtual private network (VPN), intranet or other suitable network system and includes equipment for receiving and transmitting signals.

The network 965 can also be an IP-based network for communication between the unit 901 and any external server, client and the like via a broadband connection. In exemplary embodiments, network 965 can be a managed IP network administered by a service provider. Besides, the network 965 can be a packet-switched network such as a LAN, WAN, Internet network, etc.

If the unit 901 is a PC, workstation, intelligent device or the like, the software in the memory 910 may further include a basic input output system (BIOS). The BIOS is stored in ROM so that the BIOS can be executed when the computer 901 is activated.

When the unit 901 is in operation, the processor 905 is configured to execute software stored within the memory 910, to communicate data to and from the memory 910, and to generally control operations of the computer 901 pursuant to the software. The methods described herein and the OS 911, in whole or in part are read by the processor 905, typically buffered within the processor 905, and then executed. When the methods described herein (e.g. with reference to FIG. 1) are implemented in software, the methods can be stored on any computer readable medium, such as storage 920, for use by or in connection with any computer related system or method.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects. Furthermore, aspects of the present invention may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the unit 901, partly thereon, partly on a unit 901 and another unit 901, similar or not.

Aspects of the present invention are described above with reference to flowchart illustrations and/or block diagrams of methods, apparatus (systems) and computer program products according to embodiments of the invention. It will be understood that each block of the flowchart illustrations and/or block diagrams can be implemented by one or more computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved and algorithm optimization. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

More generally, while the present invention has been described with reference to certain embodiments, it will be understood by those skilled in the art that various changes may be made and equivalents may be substituted without departing from the scope of the present invention. In addition, many modifications may be made to adapt a particular situation to the teachings of the present invention without departing from its scope. Therefore, it is intended that the present invention not be limited to the particular embodiments disclosed, but that the present invention will include all embodiments falling within the scope of the appended claims.

1. A method of distributed memory access in a network, the network including a plurality of distributed compute elements, at least one control element and a plurality of distributed memory elements, wherein a data element is striped into data segments, the data segments being imported on at least a number of the distributed memory elements by multiple paths in the network, the method comprising:
receiving, by a requesting element, credentials including an access permission for accessing the number of distributed memory elements and location information from the control element, the location information indicating physical locations of the data segments on the number of distributed memory elements; and
launching, by the requesting element, a plurality of data transfers of the data segments over the multiple paths in the network to and/or from the physical locations.

2. The method of claim 1, wherein prior to receiving credentials, the requesting element asks the control element for the credentials including the access permission and the location information.

3. The method of claim 1, wherein prior to receiving credentials, the requesting element asks the control element for the credentials and forwards the received credentials to the requesting element.

4. The method of claim 1, wherein the plurality of compute elements, the at least one control element and the plurality of memory elements are integrated in one single physical machine.

5. The method of claim 1, wherein the plurality of compute elements, the at least one control element and the plurality of memory elements are integrated in different physical machines coupled by the network.

6. The method of claim 1, wherein at least one data segment is replicated, the at least one replicated data segment being imported on at least one redundant memory element distributed in the network and controlled by the control element or at least one redundant control element.

7. The method of claim 1, wherein the data segments are replicated, the replicated data segments being imported on a number of redundant memory elements distributed in the network and controlled by the control element or at least one redundant control element.

8. The method of claim 1, wherein the data segment is located on volatile or non-volatile Random Access Memory, or where the data segment is located on a storage medium, or any hybrid combination thereof, including using the Random Access Memory as cache for the data segments on the storage medium.

9. The method of claim 1, wherein the data element is striped into data segments having a constant size.

10. The method of claim 9, further comprising configuring the size of the data segments.

11. The method of claim 1, wherein the data element is striped into data segments having different sizes.

12. The method of claim 11, further comprising configuring the different sizes of the data segments.

13. The method of claim 1, wherein multiple requesting elements are accessing one memory element of the number of memory elements storing the data segments at the same time.

14. The method of claim 1, further comprising forwarding the received access permission and the received location information from the requesting element to at least one further requesting element, wherein the distributed memory elements are configured to expose and make memory network addressable.

15. A computer readable storage medium comprising computer readable instructions stored thereon that, when executed by a computer, implement a method of distributed memory access in a network, the network including a plurality of distributed compute elements, at least one control element and a plurality of distributed memory elements, wherein a data element is striped into data segments, the data segments being imported on at least a number of the distributed memory elements by multiple paths in the network, the method comprising:
receiving, by a requesting element, credentials including an access permission for accessing the number of distributed memory elements and location information from the control element, the location information indicating physical locations of the data segments on the number of distributed memory elements; and
launching, by the requesting element, a plurality of data transfers of the data segments over the multiple paths in the network to and/or from the physical locations.

16. The computer readable storage medium of claim 15, wherein prior to receiving credentials, the requesting element asks the control element for the credentials including the access permission and the location information.

17. A system, comprising:
a network including a plurality of distributed compute elements, at least one control element and a plurality of distributed memory elements, wherein a data element is striped into data segments, the data segments being imported on at least a number of the distributed memory elements by multiple paths in the network; and
a requesting element, configured to receive credentials including an access permission for accessing the number of distributed memory elements and location information from the control element, the location information indicating physical locations of the data segments on the number of distributed memory elements; and
the requesting element configured to launch a plurality of data transfers of the data segments over the multiple paths in the network to and/or from the physical locations.

18. The system of claim 17, wherein prior to receiving credentials, the requesting element asks the control element for the credentials including the access permission and the location information.

19. The system of claim 17, wherein prior to receiving credentials, the requesting element asks the control element for the credentials and forwards the received credentials to the requesting element.

20. The system of claim 17, wherein the requesting element is further configured to forward the received access permission and the received location information from the requesting element to at least one further requesting element, wherein the distributed memory elements are configured to expose and make memory network addressable.
